(19) United States
(12) Patent Application Publication
(10) Pub. No.: US 2011/0251954 A1
(43) Pub. Date: Oct. 13, 2011

(54) ACCESS OF AN ONLINE FINANCIAL ACCOUNT THROUGH AN APPLIED GESTURE ON A MOBILE DEVICE

(75) Inventor: David H. Chin, Menlo Park, CA (US)

(73) Assignee: David H. Chin, Menlo Park, CA (US)

(21) Appl. No.: 13/166,829

(22) Filed: Jun. 23, 2011

Related U.S. Application Data
(63) Continuation-in-part of application No. 12/122,667, filed on May 17, 2008.
Application No. 12/122,667 is a continuation-in-part of application No. 13/083,632, filed on Apr. 11, 2011.

(51) Int. Cl. G06Q 40/00

(52) U.S. Cl. 705/40; 705/35; 705/39

(57) ABSTRACT

A method of accessing an online financial account through an applied gesture on a mobile device is disclosed. In one aspect, a method of a mobile device includes determining that an applied gesture on a touchscreen of a mobile device is associated with a user-defined gesture. The method may include comparing the applied gesture above the touchscreen of the mobile device with a designated security gesture and then permitting an access of an online financial account through the mobile device when the applied gesture above the touchscreen of the mobile device matches the designated security gesture.

### CLAIM OF PRIORITY

This application is a continuation-in-part and claims priority from
U.S. application Ser. No. 12/122,667 entitled ‘TOUCH-BASED AUTHENTICATION OF A MOBILE DEVICE THROUGH USER GENERATED PATTERN CREATION’ filed on May 17, 2008 and;
U.S. application Ser. No. 13/083,632 entitled ‘COMPARISON OF AN APPLIED GESTURE ON A TOUCHSCREEN OF A MOBILE DEVICE WITH A REMOTELY STORED SECURITY GESTURE’ filed on Apr. 11, 2011.

### FIELD OF TECHNOLOGY

This disclosure relates generally to online financial transactions through a mobile device, in particular the access of an online financial account through an applied gesture on a mobile device.

### BACKGROUND

An online financial account may allow a customer to conduct a financial transaction through a website operated through a financial institution. Customers may access the online financial account through a mobile device (e.g., a mobile phone, a mobile media player, a tablet computer, an Apple® iPhone®, an Apple® iPad®, a Google® Nexus S®, a HTC® Droid® etc.). Additionally, a customer may conduct a financial transaction through the mobile device.

Accessing an online financial account using a mobile electronic device may require the customer to enter a user name and password or Personal Identification Number (PIN) using a miniaturized keyboard or a virtual keypad on a touch-sensitive display screen. This process, however, may be may be slow, inconvenient, and/or cumbersome. A multi-character pass code may be difficult to remember, especially if it must be comprised of a long string of capitalized and uncapitalized letters, numbers, and symbols (as is often required by financial institutions), or if it must be changed regularly. It may be burdensome to sequentially enter a series of different alphanumeric user names and passwords or PIN's in order to gain online access to multiple different financial accounts. Furthermore, a disabled user (e.g., a visually impaired person or one with limited dexterity) may have difficulty inputting information on the keypad of a mobile device.

The online financial account accessible through the mobile device may be susceptible to a security breach. Such security breaches may result in millions of dollars in losses to the financial industry. For example, phishing may be a technique used to acquire sensitive information such a username and/or password of the online financial account through a masquerade as a trustworthy entity in an electronic communication. The online financial account of the customer may be compromised when the username and/or password is stolen, which may result in a financial loss to the customer and/or financial institution.

### SUMMARY

A method of accessing an online financial account through an applied gesture on a mobile device is disclosed. In one aspect, a method of a mobile device includes determining that an applied gesture on a touchscreen of a mobile device is associated with a user-defined gesture. The method may include comparing the applied gesture above the touchscreen of the mobile device with a designated security gesture and then permitting an access of an online financial account through the mobile device when the applied gesture above the touchscreen of the mobile device matches the designated security gesture.

The mobile device may be authenticated to access the online financial account such that a financial asset (e.g., currency, stocks, bonds, put/call options, etc.) of the online financial account is controllable through the mobile device based on the designated security gesture. Access of the online financial account may be restricted when the applied gesture above the touchscreen of the mobile device is different than the designated security gesture. A payment of a bill through the online financial account may be permitted when the applied gesture above the touchscreen of the mobile device matches the designated security gesture. The online financial account may be an online bank account.

A transfer of the financial asset of the online financial account may be permitted when the applied gesture above the touchscreen of the mobile device matches the designated security gesture. A deposit of a bank cheque to the online financial account may be permitted when the applied gesture above the touchscreen of the mobile device matches the designated security gesture. A review of an online statement of the online financial account may be permitted when the applied gesture above the touchscreen of the mobile device matches the designated security gesture.

The method may further include remotely enabling a user to define the user-defined gesture. The applied gesture and the user-defined gesture may be dependent on a scale value and a position value within an input area of the mobile device. The applied gesture and the user-defined gesture may be independent of a scale value and a position value within an input area of the mobile device. The designated security gesture may be stored in a remote computer server.

A financial transaction of the online financial account may be confirmed when the applied gesture above the touchscreen of the mobile device matches the designated security gesture. The online financial account may be an online brokerage account.

In another aspect, the method of the mobile device may include processing an applied gesture on a touchscreen of a mobile device such that an online financial account is accessible through the mobile device based on the applied gesture. The applied gesture on a touchscreen of a mobile device may be determined to be associated with a user-defined gesture. The applied gesture above the touchscreen of the mobile device may be compared with a designated security gesture. An access of the online financial account through the mobile device may be permitted when the applied gesture above the touchscreen of the mobile device matches the designated security gesture.

In yet another aspect, the method may include determining that an applied gesture on a touch-receptive area of a mobile device is associated with a user-defined gesture. The applied gesture above the touch-receptive area of the mobile device may be compared with a designated security gesture. An access of an online financial account through the mobile device may be permitted when the applied gesture above the touch-receptive area of the mobile device matches the designated security gesture.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1A illustrates a system view of an access of an online financial account through an applied gesture on a mobile device, according to one embodiment.

FIGS. 1B, 1C, 1D, 1E, and 1F illustrate a system view of a mobile device recognizing an application of a gesture in a designated region through a tactile pattern on a touch screen or on a non-display touch-receptive input area, according to one embodiment.

FIG. 2 is a block diagram illustrating the contents of a financial gesture module and the processes within the financial gesture module, according to one embodiment.

FIG. 3 is a table view illustrating various fields such as an initial state, an input gesture, another input gesture, access, action, etc., according to one embodiment.

FIG. 4A is a block diagram of a security module and a store module, according to one embodiment.

FIG. 4B is a block diagram of modules within a remote computer server, according to one embodiment.

FIG. 4C is a block diagram of an online account module and an access module that results in access to the mobile device, according to one embodiment.

FIG. 4D is a block diagram of an online account module and an access module that does not result in access to the mobile device, according to one embodiment.

FIG. 5A is a block diagram of a mobile device and a store module resident locally on the mobile device that stores a user-defined gesture locally within the mobile device, according to one embodiment.

FIG. 5B is a block diagram of a mobile device that stores an applied gesture, a match module resident locally on the mobile device that matches a user-defined gesture and the applied gesture to permit access to applications resident in a remote computer server, according to one embodiment.

FIG. 6 is a block diagram of a mobile device that gains access to a group of Internet sites through a remote computer server which stores, matches and allows access based on an association between an applied gesture and a user-defined gesture stored in the remote computer server, according to one embodiment.

FIG. 7 is a flow chart illustrating a user-defined gesture that is stored locally on a mobile device and provides access to resources on a remote computer server, according to one embodiment.

FIG. 8 is a flow chart illustrating a single sign-on gesture that provides access on the mobile device, via a remote computer server, to multiple Internet sites and social networking websites, according to one embodiment.

FIG. 9 is a diagrammatic view of a data processing system in which any of the embodiments disclosed herein may be performed, according to one embodiment.

FIG. 10A is a user interface view illustrating logging into an online financial account, according to one embodiment.

FIG. 10B is a user interface view illustrating selecting a type of transaction of the online financial account, according to one embodiment.

FIG. 10C is a user interface view illustrating paying a bill through the online financial account, according to one embodiment.

FIG. 11 is a flow diagram illustrating the access of an online financial account through an applied gesture on a mobile device, according to one embodiment.

FIG. 12 is a database view of a designated security gesture associated with a financial transaction of an online financial account, according to one embodiment.

FIG. 13 is a block diagram illustrating the contents of a financial transaction module and the processes within the financial transaction module, according to one embodiment.

FIG. 14 is a system view illustrating a financial transaction involving stocks through an applied gesture on a mobile device, according to one embodiment.

Other features of the present embodiments will be apparent from the accompanying drawings and from the detailed description that follows.

### DETAILED DESCRIPTION

Methods of accessing an online financial account through an applied gesture on a mobile device are disclosed. The applied gesture may also be applied on a non-display touch-receptive input area of a mobile device. In the following description of preferred embodiments, reference is made to the accompanying drawings which form a part hereof, and in which it is shown by way of illustration specific embodiments in which the invention can be practiced. It is to be understood that other embodiments can be utilized and structural changes can be made without departing from the scope of the preferred embodiments.

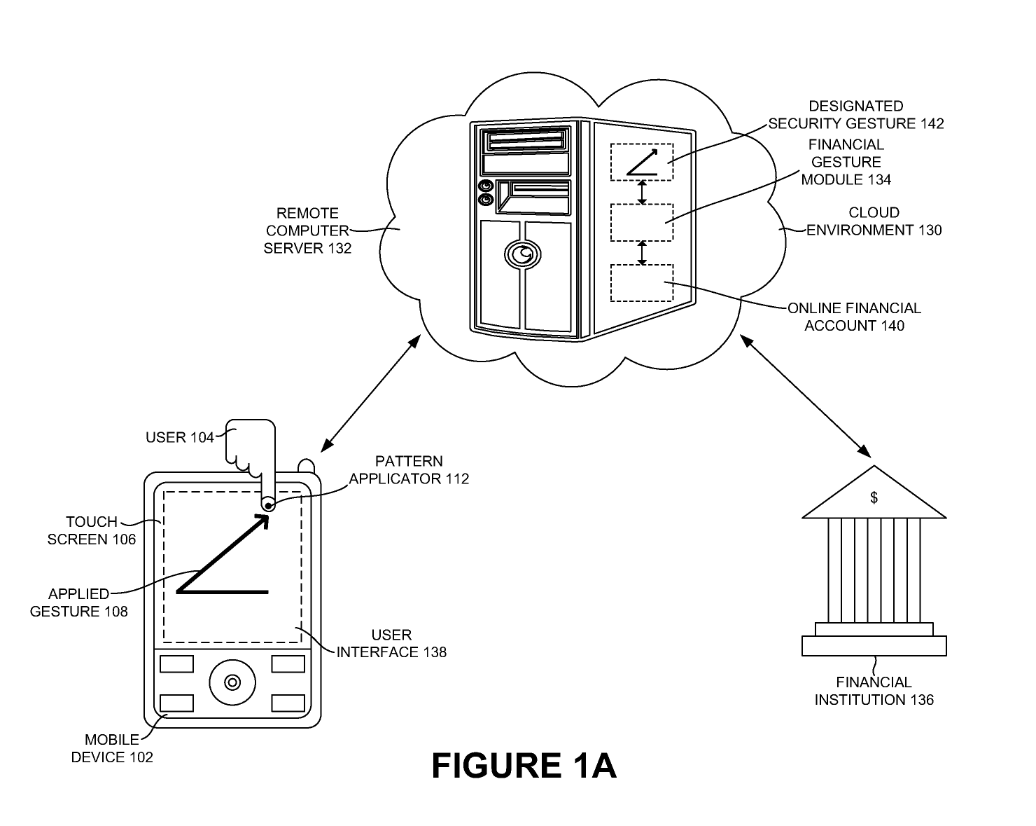

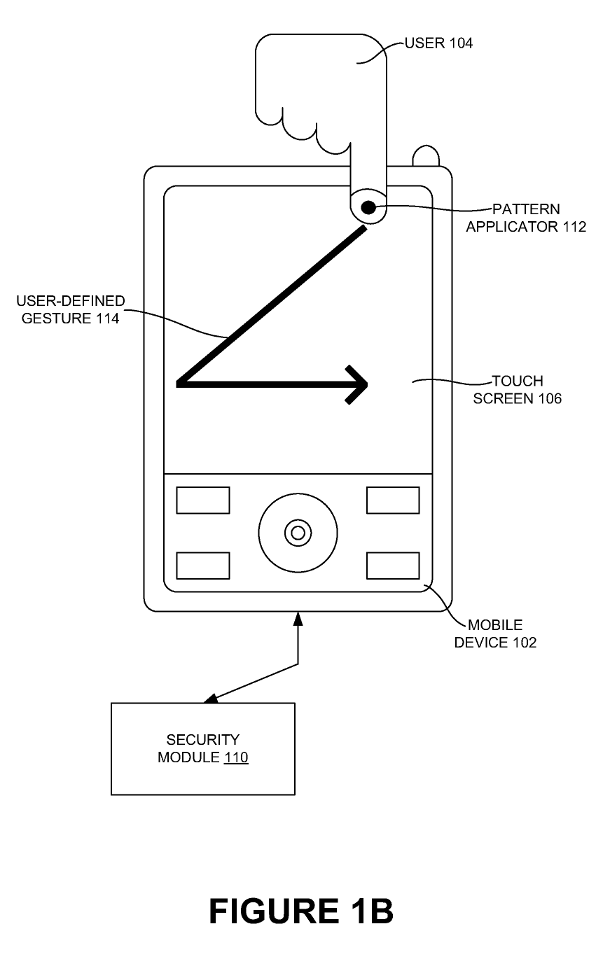

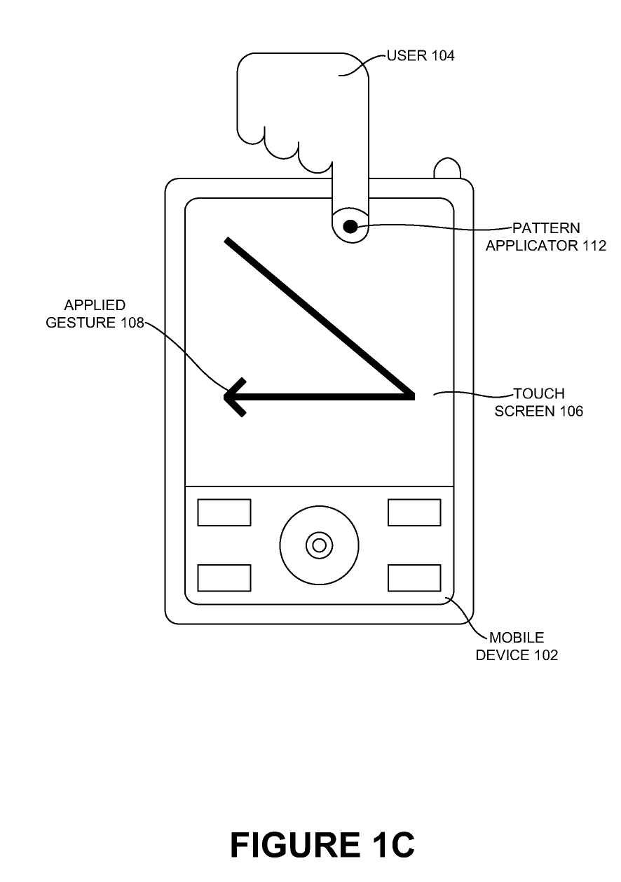

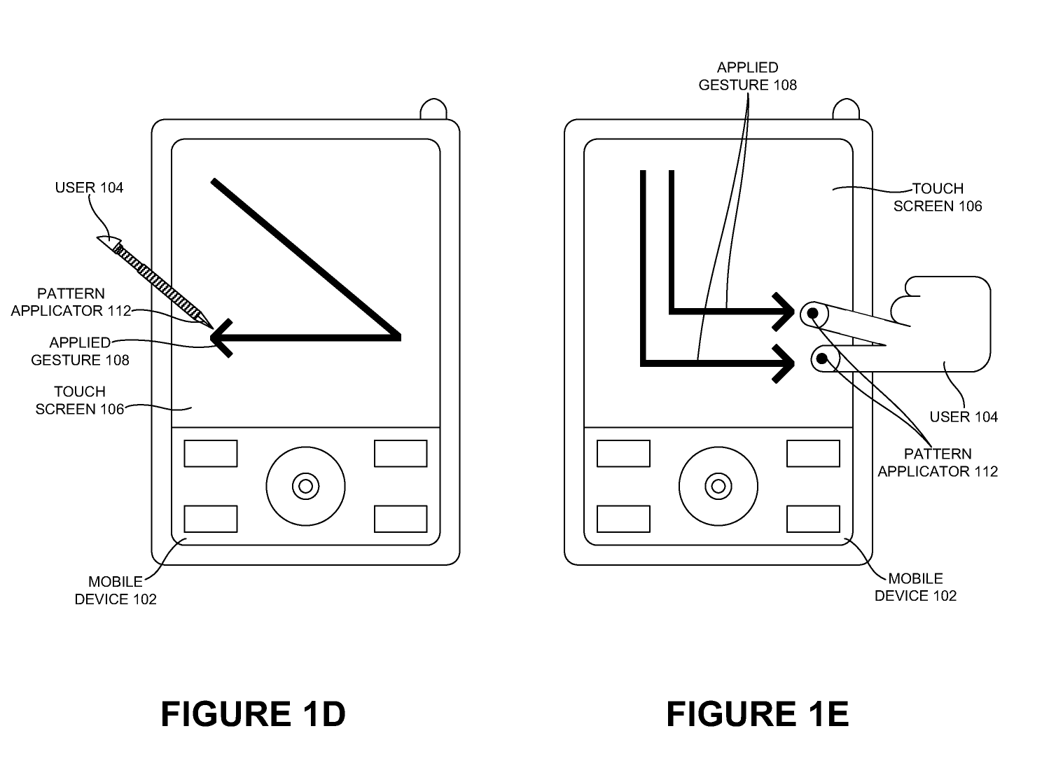

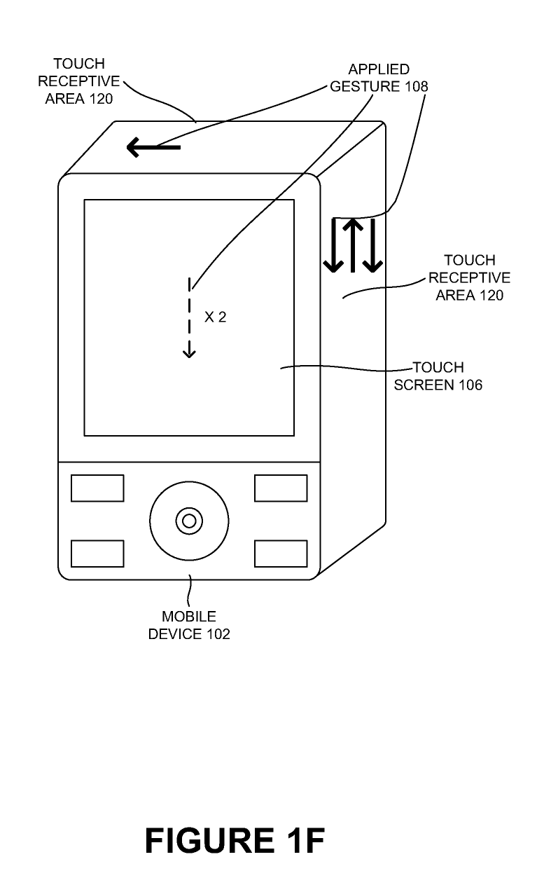

In one embodiment, a method may include accessing an online financial account 140 through an applied gesture 108 on a mobile device 102 as illustrated in FIG. 1A. FIG. 1A shows a user 104 of a mobile device 102 accessing an online financial account 140 of a financial institution 136. The user 104 may apply an applied gesture 108 on the touchscreen 106 of the mobile device to access the online financial account 140. The applied gesture 108 may be applied through a pattern applicator 112 (e.g., may be in the form of touch, etc.).

The applied gesture 108 may be a tactile gesture performed on a touchscreen 106. A touchscreen 106 may be an electronic visual display that can detect the presence and/or location of a touch within the display area. In another embodiment, the applied gesture 108 may be a tactile gesture performed on a touch-receptive area 120. The touch-receptive area 120 may be surface that can determine an applied gesture 108 based on the motion and/or position of a touch of user 104.

The mobile device 102 may be, for example, a mobile phone or a tablet computer. The mobile device 102 may access a cloud environment 130 through a network. The cloud environment 130 may be an aggregation of computational resources accessible to the mobile device 102. The cloud environment 130 may comprise a remote computer server 132. The mobile device 102 may communicate with the remote computer server though wireless communications.

The remote computer server 132 may comprise a financial gesture module 134, an online financial account 140, and/or a designated security gesture 142. The online financial account 140 may be linked to the financial institution 138 such that recent financial transactions through the financial institution 136 are updateable to the online financial account 140. Examples of financial institutions include, but are not limited to, deposit-taking institutions that accept and manage deposits and make loans, such as banks, building societies, credit unions, trust companies, and mortgage loan companies. Additional examples include insurance companies, pension funds, brokerage firms, underwriters, and investment funds.

In one embodiment, the user interface 138 of the mobile device 102 may direct the user 104 to enter the applied gesture 108 to access the online financial account 140. The financial gesture module 134 may process a request of the mobile device 102 to access the online financial account 140. The financial gesture module 134 may compare the applied gesture 108 of the mobile device 102 to the designated security gesture 142 to determine a match. If there is a match between the applied gesture 108 and the designated security gesture 142, then the online financial account 140 may be accessible to the user 104. Examples of an online financial account 140 include, but are not limited to, an online bank account, an online brokerage account, and/or an online insurance account.

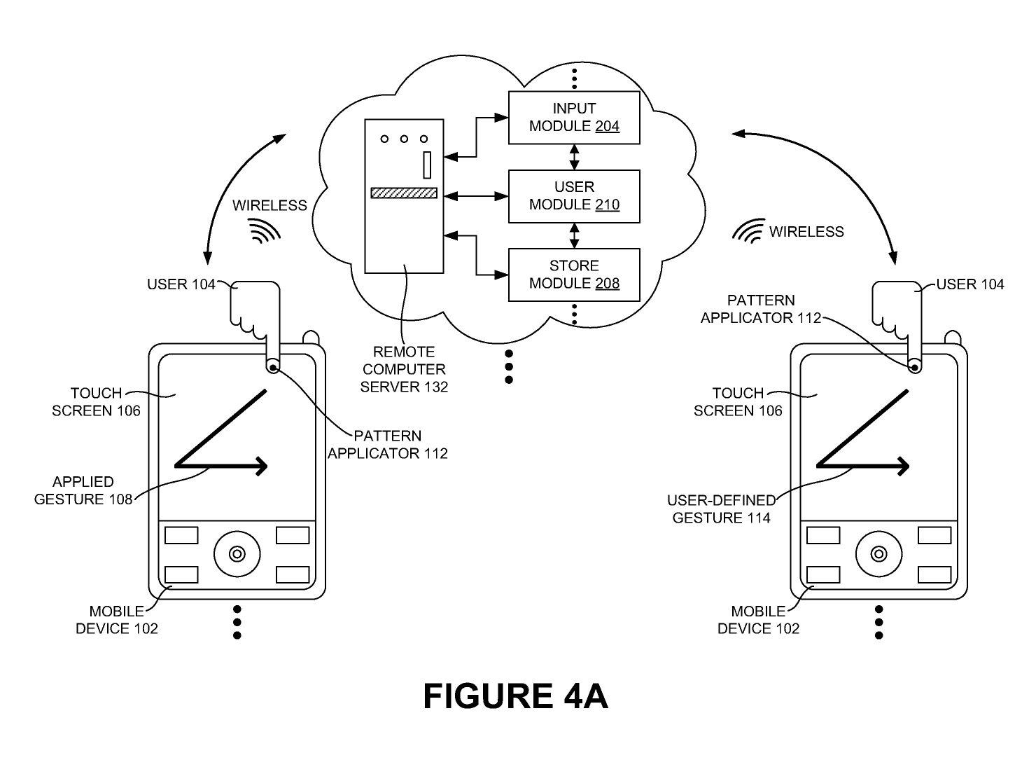

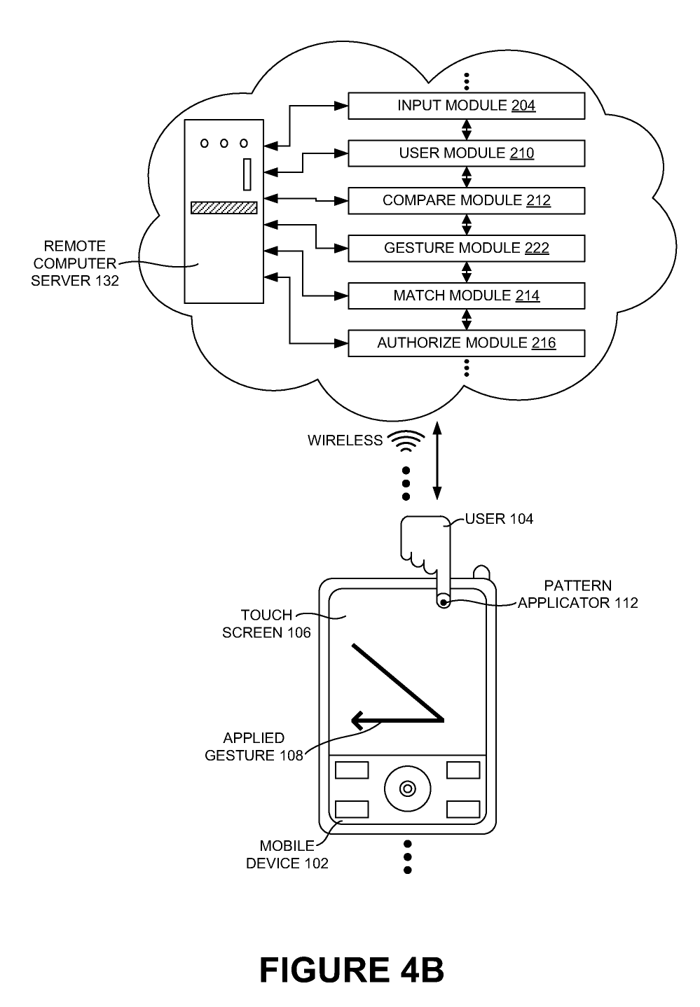

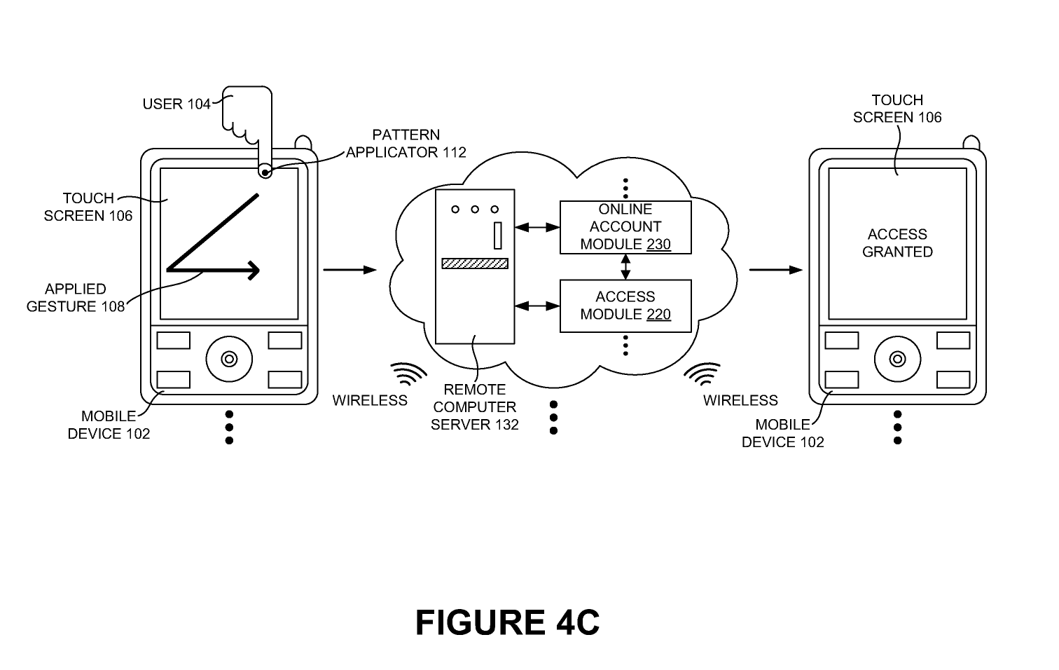

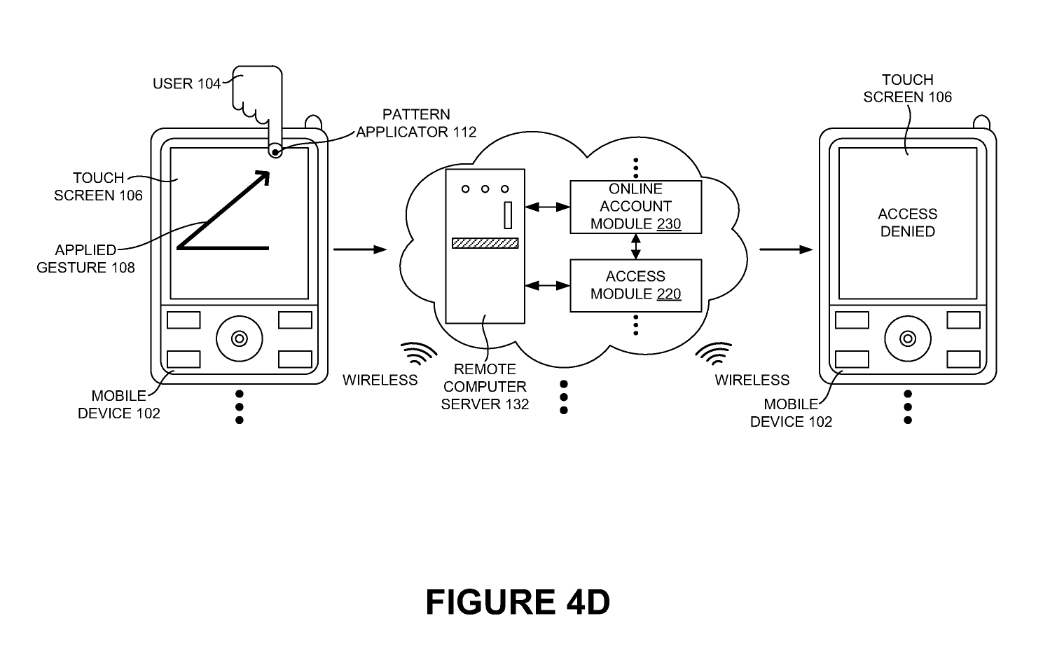

In one embodiment, a method of a mobile device 102 shown in FIGS. 1B, 1C, 1D, and 1E includes determining an applied gesture 108 on a touch screen 106 as an online account gesture is associated with a user-defined gesture 114 as shown in FIG. 1B, comparing the applied gesture 108 on the touchscreen 106 with a designated security gesture stored in a remote computer server 132 as shown in FIGS. 4A, 4B, 4C and 4D, and permitting an access of an online financial account through the mobile device 102 when the applied gesture 108 on the touchscreen 106 of the mobile device 102 matches the designated security gesture stored in the remote computer server 132. According to one embodiment, an applied gesture 108 may be a tactile gesture performed on a touch receptive area of the mobile device 102. The applied gesture 108 may be performed on a touch-receptive input area 120 of a mobile device 102, which is not the touch screen 106 of the mobile device 102. According to another embodiment, an online account gesture may be a user-defined gesture 114 or a single sign-on gesture 1108 both of which may be stored in a remote computer 132 and recognized as the designated security gesture. In another embodiment, the online account gesture may be stored in the mobile device.

In another embodiment, a method of a mobile device 102 illustrated in FIGS. 1B, 1C, 1D, and 1E includes determining whether an applied gesture 108 on a touch screen 106 is associated with a user-defined gesture (e.g., may be a gesture that may be stored in a memory that is internal to the mobile device or on a remote computer server 132), permitting access to a set of applications of the mobile device 102 when an association is made between the applied gesture 108 and the designated security gesture, and denying access to the set of applications of the mobile device 102 when the association fails to be made between the applied gesture 108 and the designated security gesture.

In another embodiment, multiple resources in a remote computer server 132 may be accessed through a mobile device 102 by accepting a user-defined gesture 114 as an input on a mobile device 102, transmitting the user-defined gesture 114 to a remote computer server 132, storing the user-defined gesture 114 in the remote computer server 132, comparing an applied gesture 108 on the mobile device 102 to the user-defined gesture 114 stored in the remote computer server 132, sending an authorizing signal to permit an access of an online financial account through the mobile device 102 if the applied gesture 108 performed on the mobile device 102 matches the user-defined gesture 114.

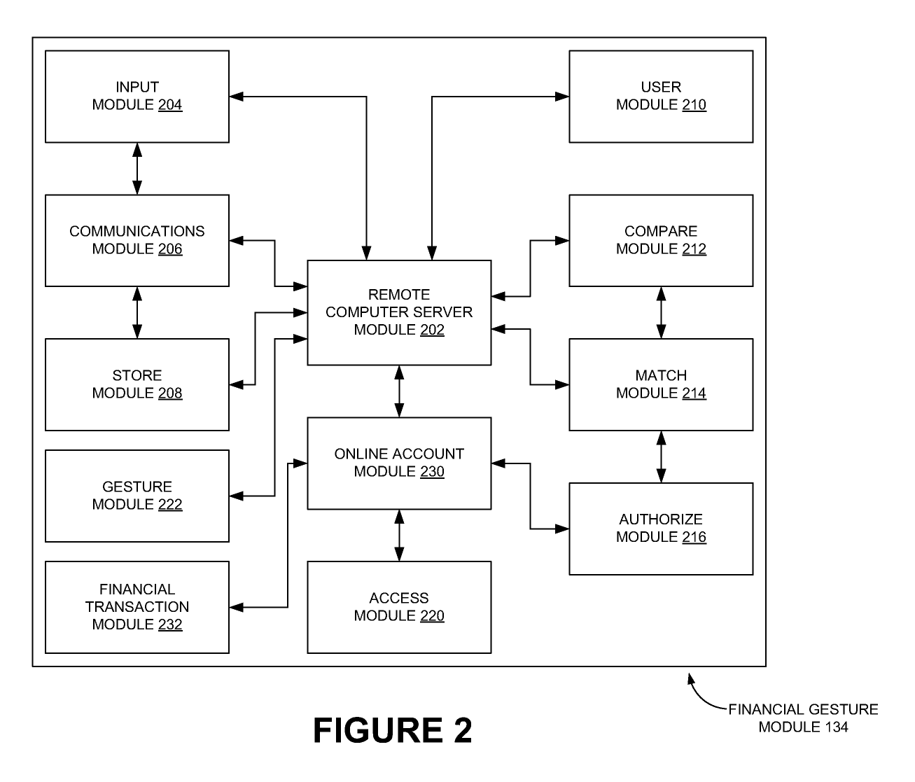

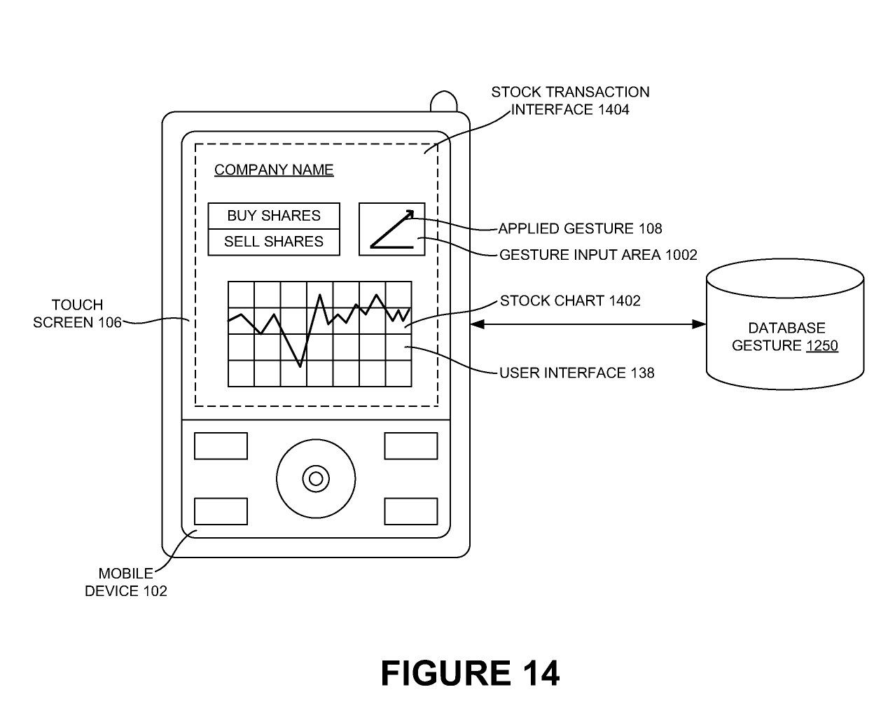

In yet another embodiment, a mobile device 102 includes a touchscreen 106 to recognize an applied gesture using a processor (e.g., the processor 1132 of FIG. 14) of the mobile device 102, a security module (e.g., the security module 110 of FIG. 1B) interfaced with the processor 1132 to associate the applied gesture 108 with a designated security gesture, and to determine access to a set of features on the mobile device 102 based on the association, and a user module (e.g., the user module 210 of FIG. 2) of the security module 110 to create security gestures based on a user input.

One exemplary embodiment may involve permitting an access of an online financial account through the mobile device 102 when the applied gesture 108 on the touchscreen 106 of the mobile device 102 matches the designated security gesture (e.g., the user-defined gesture 114) stored in the remote computer server 132, and when the applied gesture 108 is determined to be the user-defined gesture 114. Another embodiment may involve remotely enabling the user to define the user-defined gesture 114.

FIGS. 1B, 1C, 1D, and 1E illustrate a system view of a mobile device recognizing an application of an applied gesture in a designated region through a pattern applicator 112 on a touchscreen 106, according to one embodiment. The applied gesture 108 may be independent of a scale value and a position value on the touchscreen 106 or may be dependent of a scale value and a position value on the touchscreen 106. The applied gesture 108 may or may not depend on sequential activation of fixed areas on the touchscreen 106. The applied gesture 108 may be performed on any location within an input region (e.g. FIG. 1F) of the mobile device 102, for example, the non-display touch-receptive input area 120. In another embodiment, the applied gesture 108 may be applied on a touchscreen 106 comprising a visual template. The visual template may comprise multiple distinct dotted locations and/or dotted-patterning. The visual template may be a matrix visual template. Particularly, FIGS. 1B and 1C, taken together, illustrate a mobile device 102, a pattern applicator 112, an applied gesture 108, a user-defined gesture 112, a touchscreen 106, and a security module 110, according to one embodiment.

The mobile device 102 may be a device used for communication and/or for processing information (e.g., browsing, forums, mail, chat, etc.) through the network (e.g., Internet). The applied gesture 108 may be a force applied physically by the user (e.g., by touching, by using a stylus, etc.). The touchscreen 106 may be an input/output interface which may detect a location of touch within the display area. The security module 110 may provide security to the mobile device 102 based on the user-defined gesture 114 (e.g., the designated security gesture).

In one example embodiment, it may be determined that an applied gesture 108 on a touch screen 106 is associated with a user-defined gesture 114. In another embodiment, a comparison may take place between the applied gesture 108 and a designated security gesture (e.g., the online account gesture) stored in a remote computer server 132. The embodiment may involve permitting an access of an online financial account through the mobile device when the applied gesture 108 on the touch screen 106 of the mobile device 102 matches the designated security gesture stored in the remote computer server 132.

According to one embodiment, a method of remote computer server based access of a mobile device may be employed. A user-defined gesture 114 may be accepted as an input (e.g., such as an applied gesture 108) on a mobile device 102. The user-defined gesture 114 may be transmitted to and stored in a remote computer server 132. In an exemplary embodiment, a comparison may be made between the applied gesture 108 and the user-defined gesture 114 stored in the remote computer server 132. An authorization signal may be sent from the remote computer 132 to the mobile device 102 to permit access to the mobile device 102 if the applied gesture 108 matches the user-defined gesture 114. In an embodiment, if the applied gesture 108 matches the user-defined gesture 114, the mobile device 102 may be permitted to access a data resource (e.g., an application, a file, an email account, an online financial account etc.) stored in the remote computer 132.

In example embodiment, the mobile device 102 may recognize an applied gesture 108 applied through the pattern applicator 112 (e.g., may be in the form of touch, etc.) on the touchscreen 106. The pattern may be an applied gesture 108 that may be used for accessing the online financial account through the mobile device 102 or for allowing the mobile device 102 to access data and information resident on a remote computer server 132.

FIG. 2 is a block illustration of the contents of a security module 110 and processes that may occur within, according to one embodiment. Particularly, FIG. 2 illustrates an input module 204, a communications module 206, a store module 208, a gesture module 222, a remote computer server module 202, an online account module 230, an access module 220, a user module 210, a compare module 212, a financial transaction module 232, a match module 214 and an authorize module 216, according to one exemplary embodiment.

The input module 204 may accept an applied gesture 108, which may be a tactile gesture performed on the mobile device 102. The communications module 206 may communicate the applied gesture 108 to the store module 208, wherein the applied gesture 108 may be stored. The gesture module 222 may recognize the applied gesture 108 as a gesture to be compared with a user-defined gesture 114. The user module 210 may identify a user of the mobile device 102 and may recognize an input gesture by the user of the mobile device 102 as an applied gesture 108. The compare module 212 may compare the applied gesture 108 and the user-defined gesture 114 stored in the remote computer server 132. The match module 214 may match the applied gesture 108 to the user-defined gesture 114 stored in the remote computer server 132. The authorize module 216 may grant authorization for the mobile device 102 to access data resources stored in the remote computer server 132 upon matching of the applied gesture 108 and the user-defined gesture 114. The online account module 230 permits an access of an online financial account through the mobile device 102 upon receiving an authorization from the remote computer server 132 and the access module 220 permits access to data resources stored in the remote computer server 132.

According to one embodiment, the gesture module 222 may enable the mobile device 102 to recognize the application of an applied gesture (e.g., applied gesture 108) as the online account gesture. The user module 210 may detect an applied gesture as an online account gesture on the touchscreen 106. The match module 214 may match another applied gesture (e.g., an applied gesture 108) on the touchscreen 106 along with the online account gesture (e.g., a user-defined gesture 114). The store module 208 may enable storing the user-defined gesture 114 in a remote computer server 132. The authorize module 216 may authorize the mobile device 102 to access an online financial account 140.

In an example embodiment, the compare module 212 may communicate with the match module 214 which in turn may communicate with the authorize module 216 to permit the mobile device 102 to access data resources in the remote computer server 132 after the applied gesture 108 is determined to match the user-defined gesture 114. In one embodiment, the touchscreen 106 may recognize the applied gesture 108 using the gesture module 222. The security module 110 may be interfaced with the processor 1132 to associate the applied gesture 108 with a designated security gesture. The user module 210 may create security gestures based on a user input (e.g., using the user module 210 of FIG. 2).

The duration of the applied gesture 108 (e.g., using the gesture module 222 of FIG. 2) at a particular location of the touchscreen 106 may be used to determine whether it may be the designated security gesture by being associable with the user-defined gesture 114. The total time to create the applied gesture 108 (e.g., using the compare module 212 of FIG. 2) may be within a permitted amount of time when determining whether it may be the online account gesture. The mobile device 102 in the initial state may be operated such that certain functions may be disabled in the initial state to conserve battery consumption of the mobile device 102 through a power management circuitry of the mobile device 102.

It may be determined (e.g., using the compare module 212 of FIG. 2) that the online account gesture may be similar to a designated security gesture stored in the remote computer server 132 beyond a tolerance value. A different user-defined gesture 114 may be requested to be stored (e.g., using the store module 208 of FIG. 2) when the determination may be made that the online account gesture may be similar beyond the tolerance value. It may be determined (e.g., using the match module 214 of FIG. 2) that the applied gesture 108 may be unique but within an acceptance range of associability with the designated security gesture when associating the applied gesture 108 with the user-defined gesture 114. The designated security gesture may be the user-defined gesture 114 that may be stored (e.g., using the store module 208 of FIG. 2) in a memory that may be external to the mobile device 102 (e.g., in the remote computer server 132).

The online account module 230 may communicate with the online financial account 140. Once the user 104 of the mobile device 102 is authorized to access the online financial account 140, the user 104 may be permitted to access the online financial account through the access module 220. A financial transaction associated with the online financial account 140 may be permitted through the financial transaction module 232. In one embodiment, the user 104 may be permitted to perform a financial transaction once the user 104 is permitted to access the online financial account 140. In another embodiment, the user 104 may be required to re-enter an applied gesture 108 to confirm a financial transaction.

In another embodiment, access to the online financial account 140 may be verified though a facial recognition of the user 104. The camera of the mobile device 102 may capture an image of the user 104 of the mobile device 102. The image of the user 104 may be authenticated against another image of the user 104. Access of the online financial account 140 may include the facial recognition as an additional security feature to the applied gesture. In yet another embodiment, the facial recognition feature may be independent of the applied gesture feature, such that access to the financial account is based on the facial recognition.

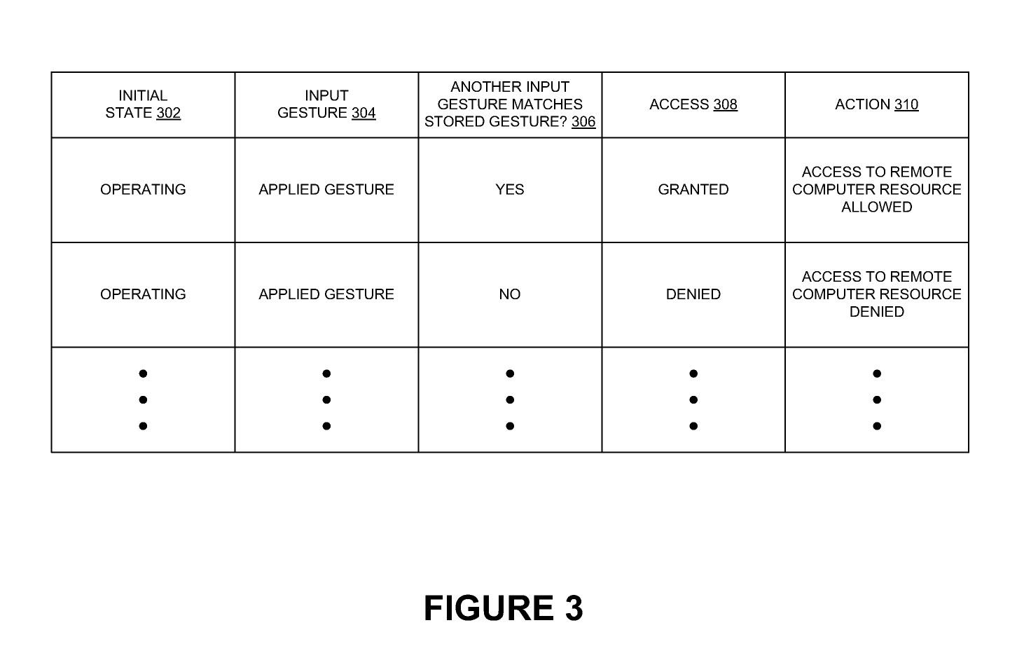

FIG. 3 is a table view illustrating various fields such as an initial state, an input gesture, another input gesture, access, action, etc., according to one embodiment. Particularly, FIG. 3 illustrates an initial state 302, an input gesture 304, whether another input gesture matches a stored gesture 306, an access 308 and an action 310.

According to an exemplary embodiment, if the initial state 302 is operating and the input gesture 304 is the applied gesture 108 and the applied gesture 108 matches the stored gesture 306, access 308 may be granted and the action 310 may result in the mobile device 102 being able to access data and resources stored on a remote computer server 132. According to another exemplary embodiment, if the initial state 302 is operating and the input gesture 304 is the applied gesture 108 and the applied gesture 108 does not match the stored gesture 306, access 308 may be denied and the mobile device 102 may not be able to access data and resources stored on a remote computer server 132.

According to an embodiment, a method of accessing a remote data resource stored on a remote computer server 132 on a mobile device 102 may be implemented. A user-defined gesture 114 may be stored in a remote computer server 132. An applied gesture 114 may be accepted as an input on a mobile device 102. The applied gesture 108 may be transmitted to the remote computer server 132 and compared with the user-defined gesture 114 stored in the remote computer server 132. According to an embodiment, an authorizing signal may be sent to the mobile device 102 to permit access to a data resource (e.g., an email account, an application, a file, an Internet site, an online financial account etc.) resident on the remote computer server 132 or any other remote computer server.

FIG. 4A illustrates a system view of an exemplary embodiment of the invention. The applied gesture 108 in FIG. 4A may be entered by a user 104 on a gesture-receptive area of the mobile device 102. The touch screen 106 is configured to recognize an applied gesture 108 applied to the touch screen 106 of the mobile device 102 by a pattern applicator 112 (e.g., the user 104 of FIG. 4A, but may also include a stylus-based pattern applicator as shown in FIG. 1D). The applied gesture 108 may be wirelessly sent from the mobile device 102 to be matched against the user-defined gesture 114 which may be already stored in the remote computer server 132. The input module 204 may recognize that the applied gesture 108 may be an online account gesture of the mobile device 102 and the user module 210 may recognize that the applied gesture 108 is a user-defined gesture 114 to be stored in the remote computer server 132 (e.g., using the store module 208 in FIG. 4A).

In another embodiment, a user-defined gesture 114 may be applied on the touch screen 106 of the mobile device 102. The user-defined gesture 114 may be wirelessly sent from the mobile device 102 to be stored in the remote computer server 132. The input module 204 may recognize that the user-defined gesture 114 may be an online account gesture of the mobile device 102 and the user module 210 may recognize that the user-defined gesture 114 is a designated security gesture 114 once the user-defined gesture 114 is stored in the remote computer server 132 (e.g., using the store module 208 in FIG. 4A).

FIG. 4B is system view of yet another embodiment of the invention. The applied gesture 108 in FIG. 4B may be entered by a user 104 on a touch screen 106 of the mobile device 102. The applied gesture 108 may then be wirelessly transmitted from the mobile device 102 to a remote computer server 132. The remote computer server 132 may contain an input module 204 to recognize the applied gesture 108 on the touch screen 106, a user module 210 may designate the applied gesture 108 as coming from a user 104, a gesture module 222 may recognize the applied gesture 108 as the online account gesture, a compare module may compare the applied gesture 108 and the user-defined gesture 114 stored in the remote computer server 132 as a designated security gesture.

FIG. 4C is a system view of an exemplary embodiment of the invention. The applied gesture 108 in FIG. 4C may be applied on a touch screen 106 of a mobile device 102 by a user 104 or a stylus-based pattern applicator as shown in FIG. 1D. The applied gesture 108 may then be transmitted to a remote computer server 132 wherein the online account module 230 may permit the mobile device 102 to access a data resource stored in the remote computer server 132 (e.g., using the access module 220 in FIG. 4C) if the applied gesture 108 matches the user-defined gesture 114 stored in the remote computer server 132 as a designated security gesture.

FIG. 4D is a system view of an exemplary embodiment of the invention. The applied gesture 108 in FIG. 4D may be applied on a touch screen 106 of a mobile device 102 by a user 104 or a stylus-based pattern applicator as shown in FIG. 1D. The applied gesture 108 may then be transmitted to a remote computer server 132 wherein the online account module 230 may restrict the mobile device 102 and may restrict access to a data resource stored in the remote computer server 132 (e.g., using the access module 220 in FIG. 4C) if the applied gesture 108 does not match the user-defined gesture 114 stored in the remote computer server 132 as the designated security gesture.

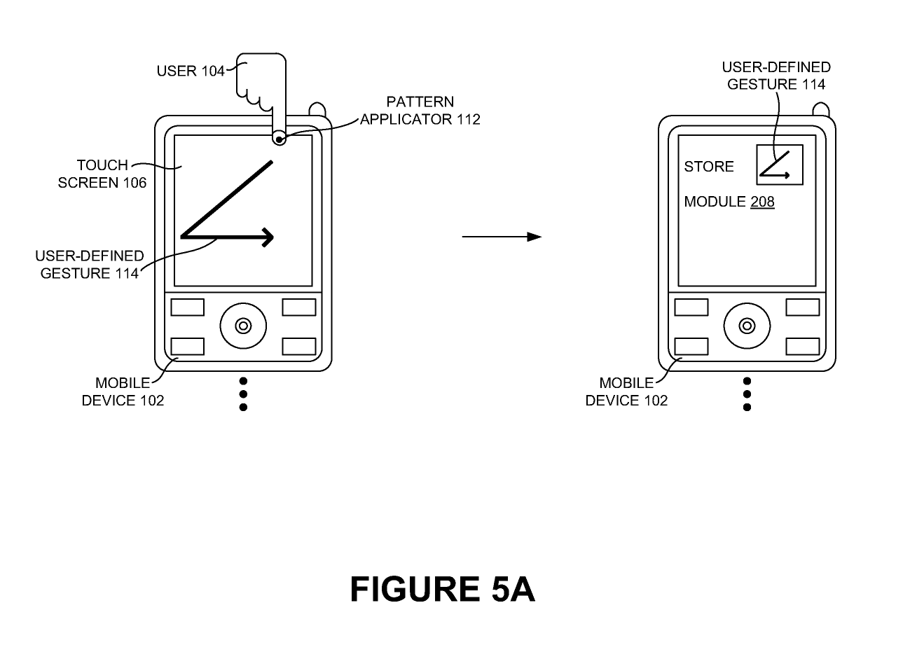

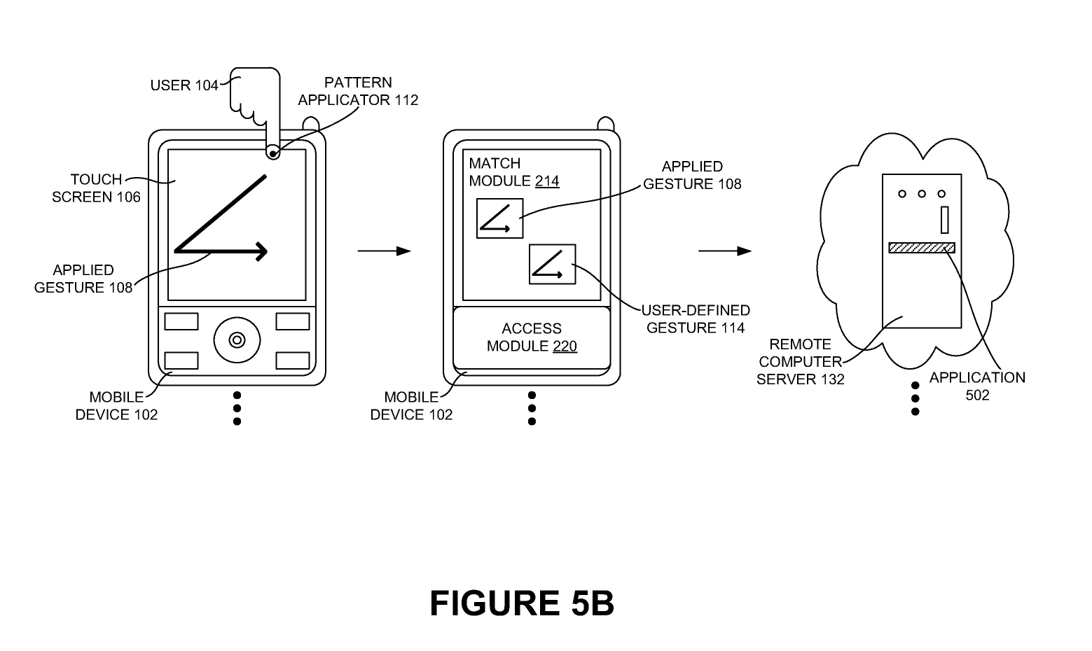

FIG. 5A is a system view of the store module 208 as illustrated in FIG. 2, according to one embodiment. According to another embodiment, a user-defined gesture 114 may be performed on a touch screen 106 of a mobile device 102 by a user 104. The user-defined gesture 114 may be stored internally within the mobile device 102. In another embodiment, as illustrated by FIG. 5B, an applied gesture 108 may be compared with the user-defined gesture 114 within a match module 214 internal to the mobile device 102. If an association is made between the applied gesture 108 and the user-defined gesture 114, access to an application 1008 resident on the remote computer server 132 via the mobile device 102 may be permitted, according to one embodiment. The application 502 may be any software application resident on the remote computer server 132 (e.g., a finance application, a word processing application, a social-media application, a web-based application, a cloud-based application, an online financial account, etc.).

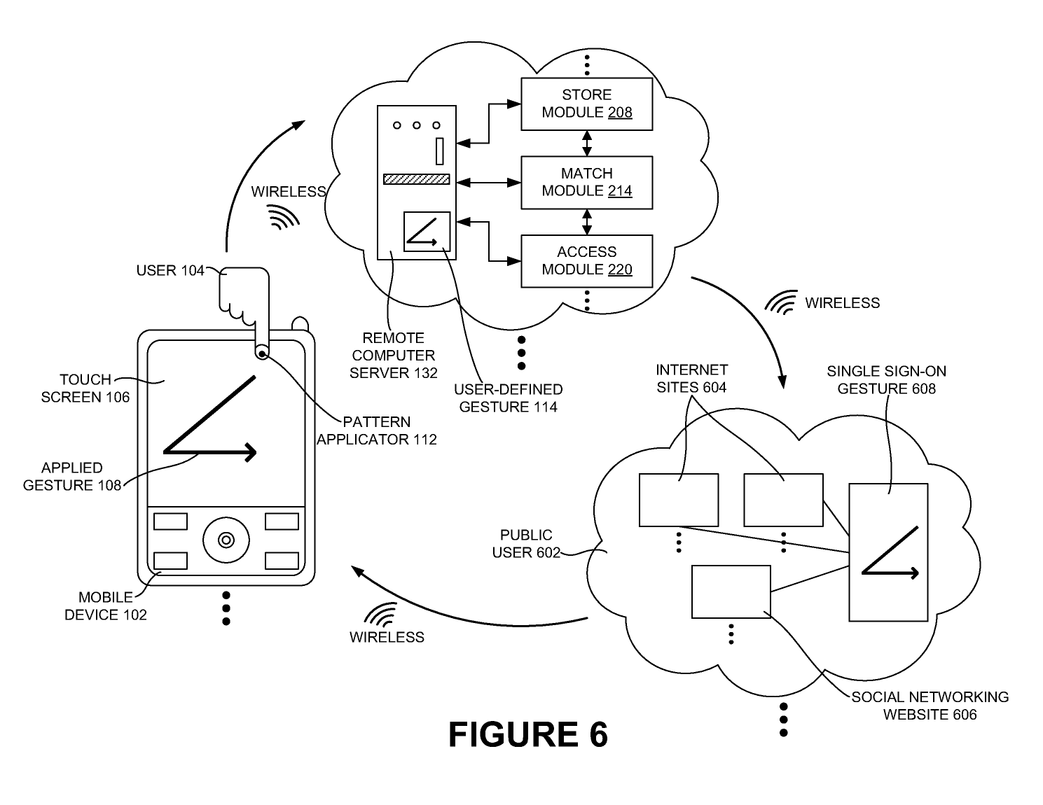

In another exemplary embodiment, as illustrated by FIG. 6, the applied gesture 108 may be associated with a single sign-on gesture 608 once it has been established that the applied gesture 108 matches the user-defined gesture 114 stored in the remote computer server 132. An applied gesture 108, applied on a touch screen 106 of a mobile device 102 using a pattern applicator 112 may be wirelessly transmitted to a remote computer server 132. The store module 208 of FIG. 2 may store the user-defined gesture 114 in the remote computer server 132 for the purpose of matching the user-defined gesture 114 to the applied gesture 108 (e.g., using the match module 214 of FIG. 2). The access module 220 as shown in FIG. 2 may provide access to a plurality of resources found in a public web 602 (e.g., Internet sites 604, social networking website 606, etc.) directly through the mobile device 102 with the single sign-on gesture 608 so long as the single sign-on gesture 608 is an applied gesture 108 and matches the user-defined gesture 114 stored in the remote computer server 132 as the designated security gesture. The single sign-on gesture 608 may allow instant simultaneous access to a multitude of different online financial accounts (e.g., Wells Fargo, Fidelity Investments, Charles Schwab, etc.).

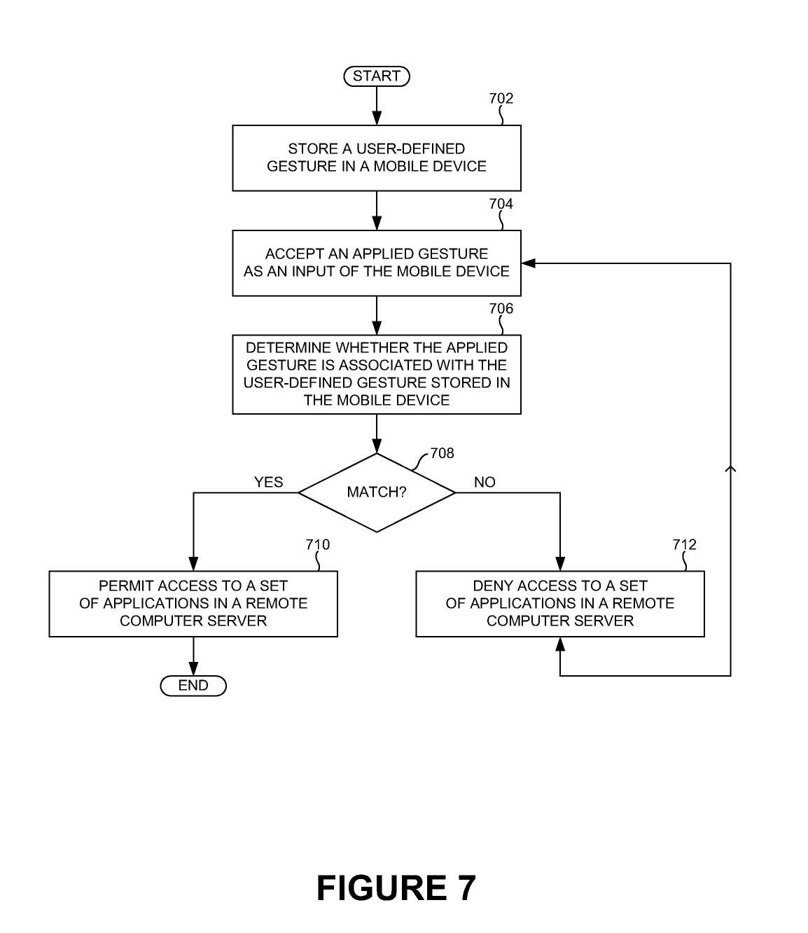

In another exemplary embodiment, the user-defined gesture 114 may be stored locally inside the mobile device (e.g., on a memory resident within the mobile device 102) as illustrated in operation 702 in the flow chart of FIG. 7. In operation 704, an applied gesture 108 may be accepted as an input of the mobile device 102. It may then be determined in operation 706 whether the applied gesture 108 is associated with the user-defined gesture 114, wherein the user-defined gesture 114 is stored internally within the mobile device 102. A comparison and a match may be performed, in operation 708, between the applied gesture 108 and the user-defined gesture 114. If the applied gesture 108 matches the user-defined gesture 114, the user 104 may be allowed access to a set of applications stored in a remote computer server 132 (e.g., a finance application, a word processing application, a social-media application, a web-based application, a cloud-based application, etc.) in operation 710. If the applied gesture 108 does not match the user-defined gesture 114, the user 104 may be denied access to a set of applications stored in a remote computer server 132 (e.g., a finance application, a word processing application, a social-media application, a web-based application, a cloud-based application, etc.) in operation 712.

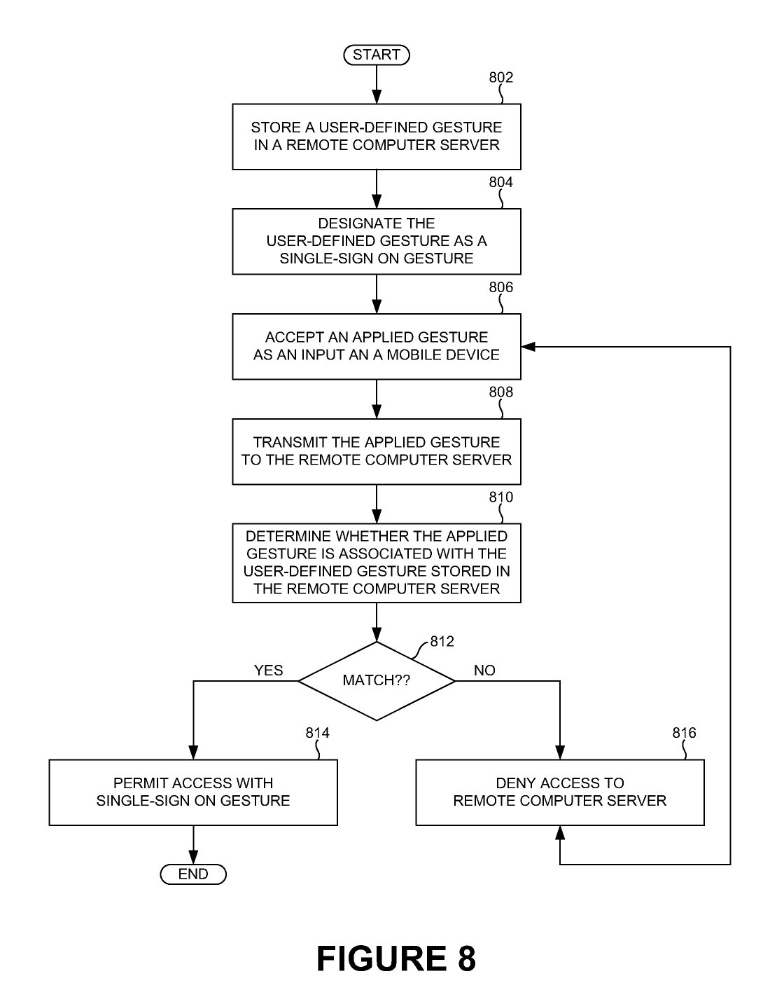

FIG. 8 is a flow chart illustrating an exemplary embodiment wherein a single sign-on gesture 608 is designated as the designated security gesture if the applied gesture 108 on a touch screens 106 of a mobile device 102 matches the user-defined gesture 114 stored in a remote computer server 132. According to one embodiment, in operation 802, a user-defined gesture 114 may be stored in a remote computer 132. In operation 804, the user-defined gesture 114 may then be designated as a single sign-on gesture 608. In operation 806, a mobile device 102 may be configured to accept an applied gesture 108 as an input and may transmit, in operation 808, the applied gesture 108 to the remote computer server 132 for comparison with the stored single sign-on gesture 608. If it is determined in operation 810, that the applied gesture 108 is associated with the user-defined gesture 114 stored in the remote computer server 132, through a match in operation 812, access is permitted with the single sign-on gesture 608 to a plurality of resources found in a public web 602 (e.g., Internet sites 604, social networking website 606, etc.) in operation 814. If there is no match between the applied gesture 108 and the user-defined gesture 114, access is denied to the resource found in the public web 602 (e.g., Internet sites 604, social networking website 606, etc.) in operation 816.

In one embodiment, a tactile pattern may be determined (e.g., the applied gesture 108) on the touchscreen 106 may be associated with a designated security gesture. The access may be permitted to a set of applications of the mobile device 102 when an association may be made between the applied gesture 108 and the designated security gesture, which may be stored in a remote computer server 132. The access may be denied to the set of applications of the mobile device 102 when the association fails to be made between the applied gesture 108 and the designated security gesture, which may be stored in a remote computer server 132.

In another embodiment, there may be various rules/references that may enable the user 104 to access an online financial account 140 through the mobile device 102 through the use of tactile patterns or security gestures applied on the touch screen 106 or touch-receptive non-display input regions 120 of the mobile device 102. The input gesture 304 may be the gestures that may be accepted after determining the match between another tactile pattern and online account gesture may be under matching conditions (e.g., may be approximately). The rejected gestures may be the gestures that may be rejected after determining the match between another tactile pattern and the online account gesture may not be within the matching conditions.

In an example embodiment, an applied gesture 108 may comprise a tactile pattern consisting of application by a pattern applicator 112 within a designated touch-sensitive input region of an arbitrarily complex spatial or temporal pattern of tactile forces. The tactile pattern of the applied gesture 108 may consist of one or more simultaneous or sequential point or vector tactile forces. A vector tactile force may consist of directional linear or complex curvilinear components. The gesture may include a temporal element. For example, the applied gesture 108 may include linear applications of force by the object across the touch screen 106, taps against the touch screen 106, static applications of the object in contact with the touch screen 106 for a specified period of time, or any combination thereof. The applied gesture 108 may be composed by the authorized user of the mobile device 102.

The applied gesture 108 may be applied with or without the aid of a visual template. A designated input region may represent a fixed or variable subset of the touch screen 106 or may coincide with the entire touch screen 106. The applied gesture 108 applied or path traced by one's finger or force applicator may or may not be visually indicated on the screen, and successful or unsuccessful application of the gesture may or may not be acknowledged by specific visual, audible, or haptic feedback.

According to one embodiment, the applied gesture 108 may be applied dependent or independent of its relative scale or position within the designated input region of the touch screen 106. The length and width of a two-dimensional spatial pattern performed on the surface of the touch screen 108 may or may not vary in magnitude between different applications by a user or different users. The location of the touch screen 106 on which the two-dimensional spatial pattern is performed by the user may or may not vary. Nevertheless, the two-dimensional spatial pattern may permit access to a remote computer resource 132 if the ratio of the dimensions of the length and width of the two-dimensional spatial pattern are substantially similar to the ratio of the length and width of the tactile pattern of the applied gesture 108.

According to one example, the designated security gesture may consist of a “forward double-L,” applied by simultaneously moving two adjacent fingers vertically down on a touch screen 108 a distance x and then contiguously moving both fingers ninety degrees to right a distance of 0.5×. The applied gesture 108 may or may not be scale and position independent with respect to the designated input region or the touch screen 106. The size of the applied gesture 108 may be small, medium, or large relative to the size of the designated input region. The applied gesture 108 may be applied anywhere (for example, in the top left quadrant or anywhere on the right side) on the mobile device 102.

According to another example, the user may compose the applied gesture 108 consisting of the approximately simultaneous application on a touch screen 106 of three equally-spaced point contacts arrayed linearly in a horizontal orientation. These three point touches may be applied near the top or anywhere else within the designated input region and may be relatively small or large compared to the size of the designated input region of the mobile device 102.

According to another example, the applied gesture 108 may be applied with a force applicator (e.g., a stylus) on the touch screen 106 followed by holding the object in contact with the touch screen 106. According to one embodiment, an online account gesture may be applied at any location within a designated touch-sensitive input region of a mobile device 102. The designated input region may be a touch screen 106 or some other touch-sensitive non-display input region 120 of the mobile device 102, such as its back, an edge, or a touch pad. The scale of the applied gesture 108 may be of any size relative to the designated input region of the touch screen 106 or touch-sensitive non-display input region 120 of the mobile device 102, according to one embodiment.

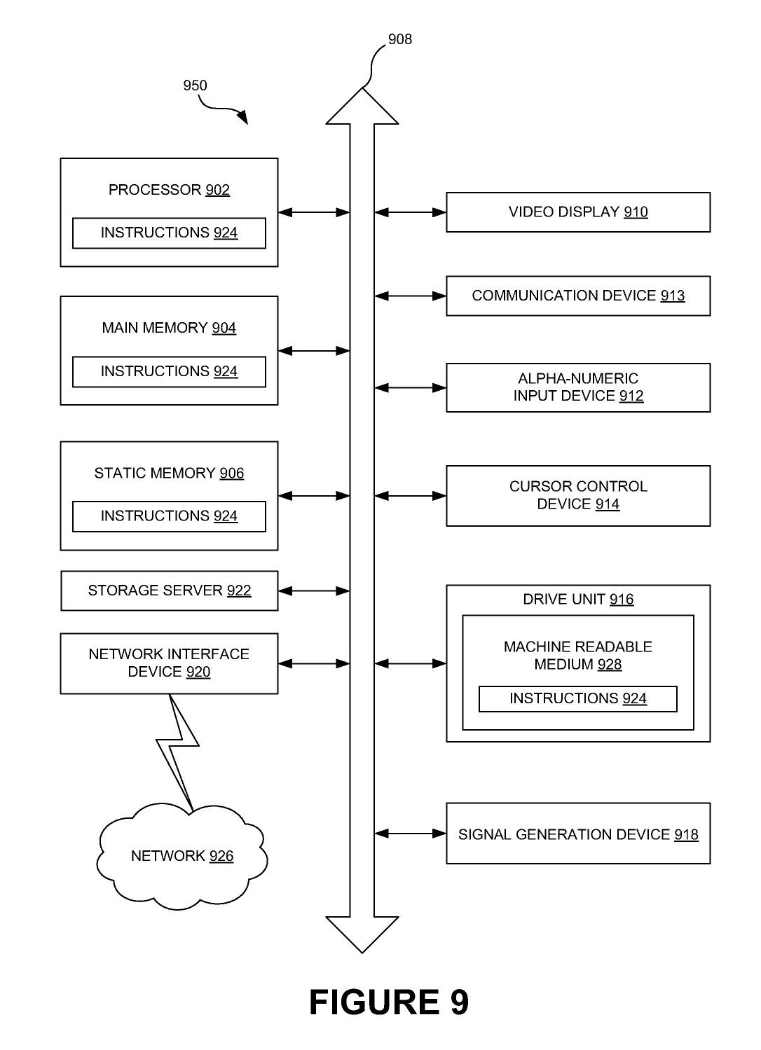

FIG. 9 may indicate a personal computer and/or the data processing system 950 in which one or more operations disclosed herein may be performed. The security module 110 may provide security to the device from unauthorized access (e.g., may be mishandled, misused, stolen, etc.). The processor 902 may be a microprocessor, a state machine, an application specific integrated circuit, a field programmable gate array, etc. (e.g., Intel® Pentium® processor, 620 MHz ARM 1176, etc.). The main memory 904 may be a dynamic random access memory and/or a primary memory of a computer system.

The static memory 906 may be a hard drive, a flash drive, and/or other memory information associated with the data processing system. The bus 908 may be an interconnection between various circuits and/or structures of the data processing system. The video display 910 may provide graphical representation of information on the data processing system. The alpha-numeric input device 912 may be a keypad, a keyboard, a virtual keypad of a touchscreen and/or any other input device of text (e.g., a special device to aid the physically handicapped).

The cursor control device 914 may be a pointing device such as a mouse. The drive unit 1416 may be the hard drive, a storage system, and/or other longer term storage subsystem. The signal generation device 918 may be a bios and/or a functional operating system of the data processing system. The network interface device 920 may be a device that performs interface functions such as code conversion, protocol conversion and/or buffering required for communication to and from the network 926. The machine readable medium 928 may be within a drive unit 916 and may provide instructions on which any of the methods disclosed herein may be performed. The communication device 913 may communicate with the user 104 of the data processing system 950. The storage server 922 may store data. The instructions 924 may provide source code and/or data code to the processor 902 to enable any one or more operations disclosed herein.

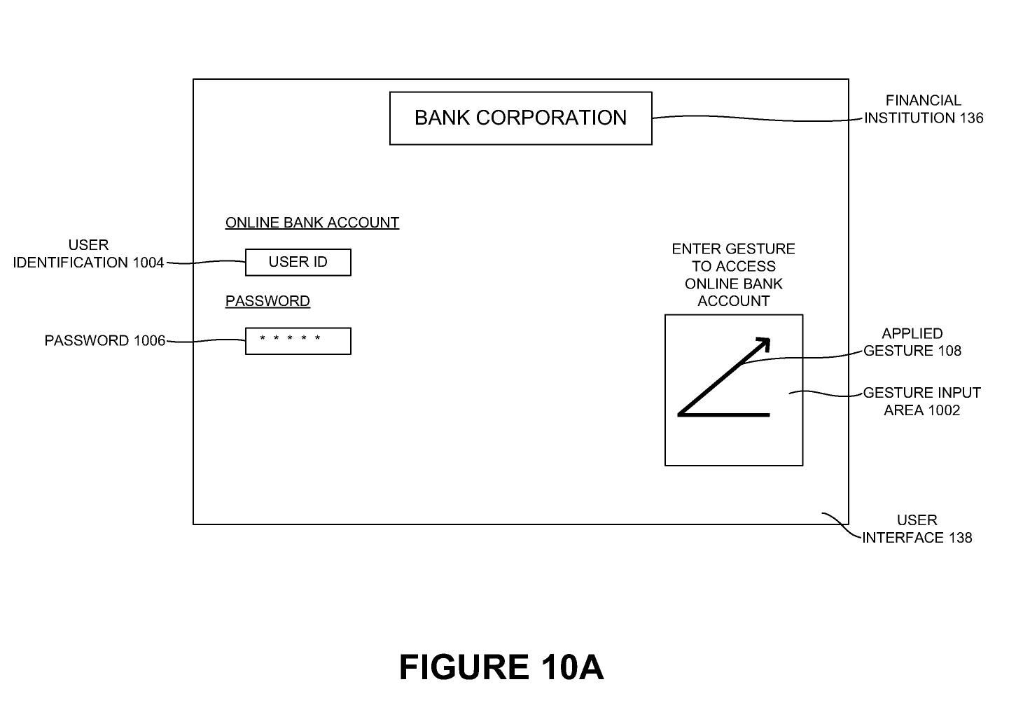

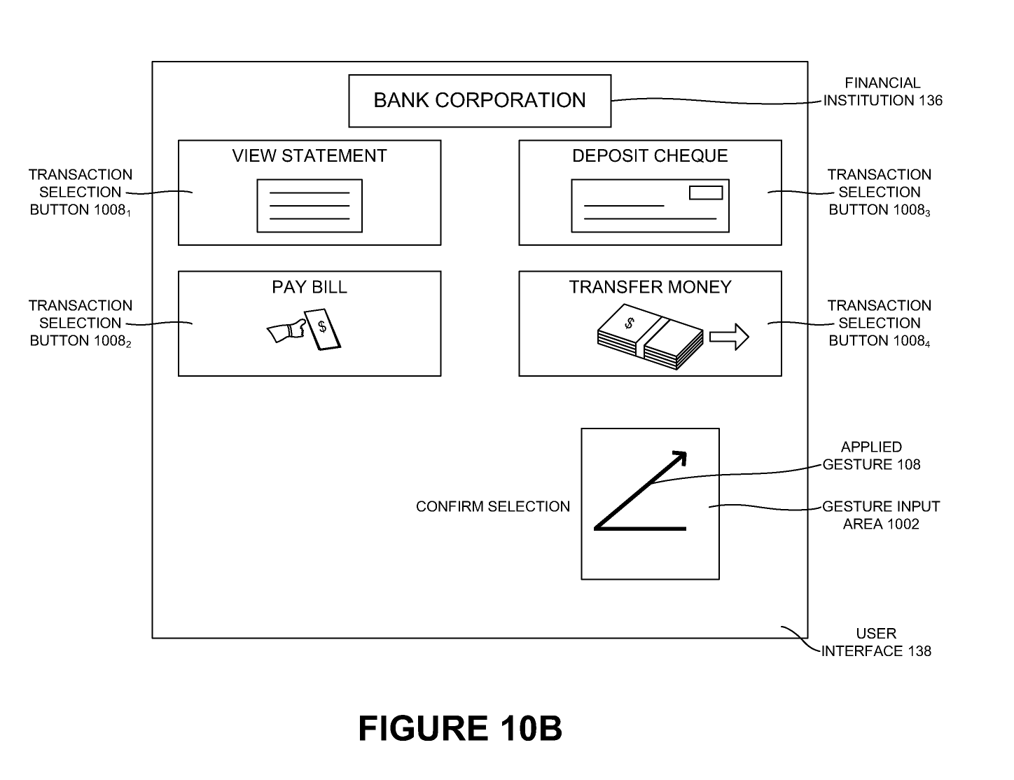

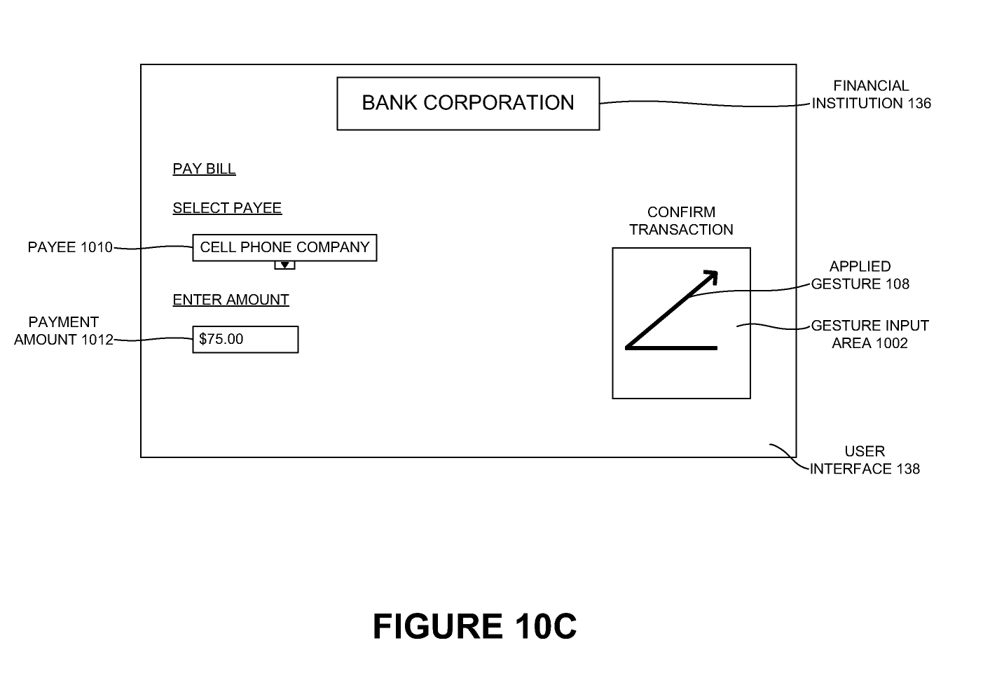

FIG. 10A is a user interface view illustrating logging into an online financial account, according to one embodiment. A user 104 may access an online financial account 140 through the user interface 138 of the mobile device 102. As an illustrative example, the online financial account 140 may be an online bank account and the financial institution 136 may be a bank.

In one embodiment the user 104 may enter a user identification 1004 and/or password 1006. In another embodiment, the user identification 1004 and/or password 1006 may be automatically populated based on a cookie. A cookie may be a piece of text stored on the mobile device 102 of the user 104 by a web browser. In yet another embodiment, the mobile device 102 may include a unique identification associated with the online bank account such that the user identification 1004 and/or password 1006 may not be required.

The user 104 may be required to enter an applied gesture 108 on the gesture input area 1002 of the user interface 138 to access the online bank account. The applied gesture 108 may be compared to the designated security gesture 142 to determine access privileges. The user 104 may make a financial transaction after permission has been granted to access the online financial account 140.

FIG. 10B is a user interface view illustrating selecting a type of transaction of the online financial account, according to one embodiment. As an illustrative example, once the user 104 has permission to access the online bank account, the user 104 may select a type of transaction the user 104 wishes to complete through a transaction selection button 1008. Examples of types of financial transactions associated with banking include view statement, pay bill, deposit cheque, and transfer money.

In one embodiment, the user 104 may be required to confirm the selection of the type of transaction through the applied gesture 108 on the gesture input area 1002 of the user interface 138. In another embodiment, the user may not be required to confirm the selection of the type of transaction through the applied gesture 108. Instead, permission to select the type of transaction may be granted based on the initial applied gesture 108 to access the online bank account. In yet another embodiment, the applied gesture 108 to confirm a selection of the type of transaction may be a different gesture than the applied gesture 108 to access the online bank account. For example, the user 104 may designate the designated security gesture 142 as the security gesture to access the online financial account and designate another designated security gesture as the security gesture to confirm a financial transaction through the online financial account. In one embodiment, the designated security gesture 142 may be different than the another designated security gesture. In another embodiment, the designated security gesture 142 may be the same as the another designated security gesture.

FIG. 10C is a user interface view illustrating paying a bill through the online financial account, according to one embodiment. As an illustrative example, a user 104 through the user interface 138 may select a payee 1010 and/or enter a payment amount 1012 owed to the payee 1010. In one embodiment, the user 104 may confirm the financial transaction to pay the bill to the payee 1010 through an applied gesture 108 on the gesture input area 1002 of the user interface 138. Confirming a financial transaction through an applied gesture 108 may increase the security of the financial transaction. Financial transactions such as buying and/or selling stocks may be confirmed through an applied gesture 108.

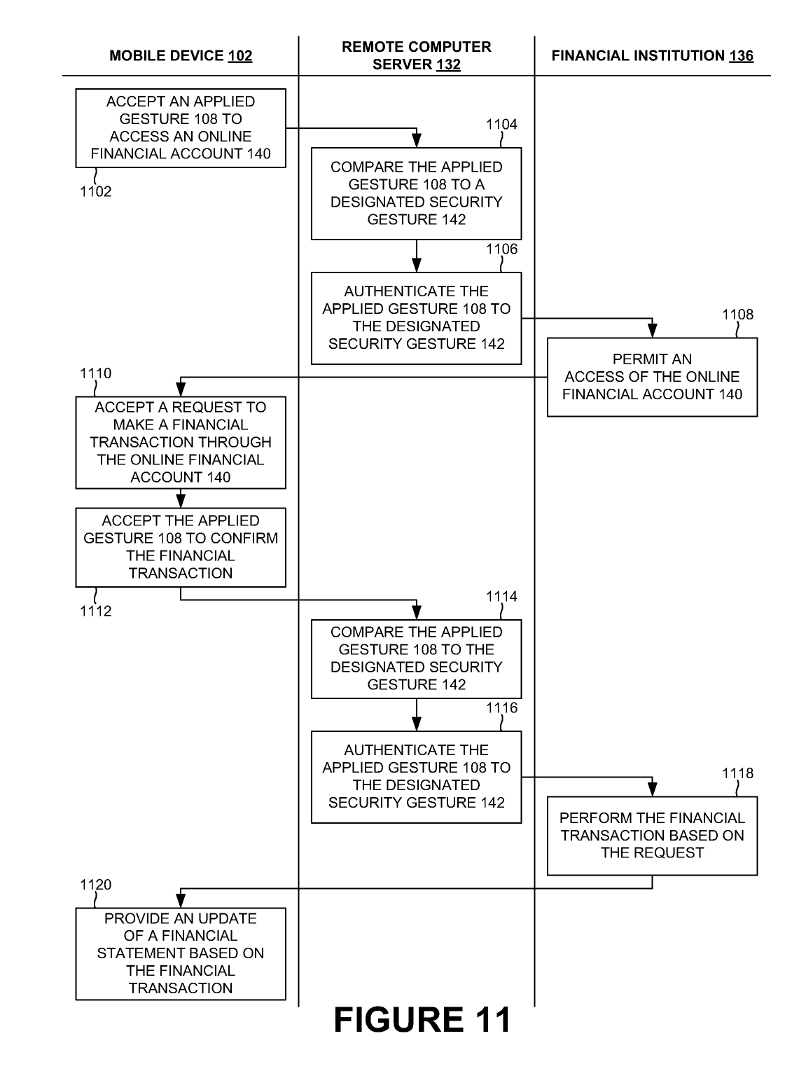

FIG. 11 is a flow diagram illustrating the access of an online financial account through an applied gesture on a mobile device, according to one embodiment. In operation 1102, the mobile device 102 may accept an applied gesture 108 of the user 104 to access the online financial account 140. In operation 1104, the remote computer server 132 may compare the applied gesture 108 to a designated security gesture 142. If there is a match between the applied gesture 108 and the designated security gesture 142, then the user may access the online financial account 140. In operation 1106, the remote computer server may authenticate the applied gesture 108 to the designated security gesture 142.

In operation 1108, the financial institution 136 may provide an access of the online financial account 140 to the user 104 based on the authorization of the user 104 through the remote computer server 132. In operation 1110, the mobile device 102 may accept a request to make a financial transaction through the online financial account 140. In an example embodiment in operation 1112, the mobile device 102 may accept the applied gesture 108 to confirm the financial transaction. Confirming the financial transaction through the applied gesture 108 may increase the security of the financial transaction.

In operation 1114, the remote computer server 132 may compare the applied gesture 108 to the designated security gesture 142 to confirm the financial transaction. In operation 1116, the remote computer server may authenticate the applied gesture 108 to the designated security gesture 142. In operation 1118 after the financial transaction been confirmed, the financial institution 136 may perform the financial transaction based on the request of the user 104. In operation 1120, the mobile device 102 may provide an update of a financial statement based on the financial transaction to the user 104.

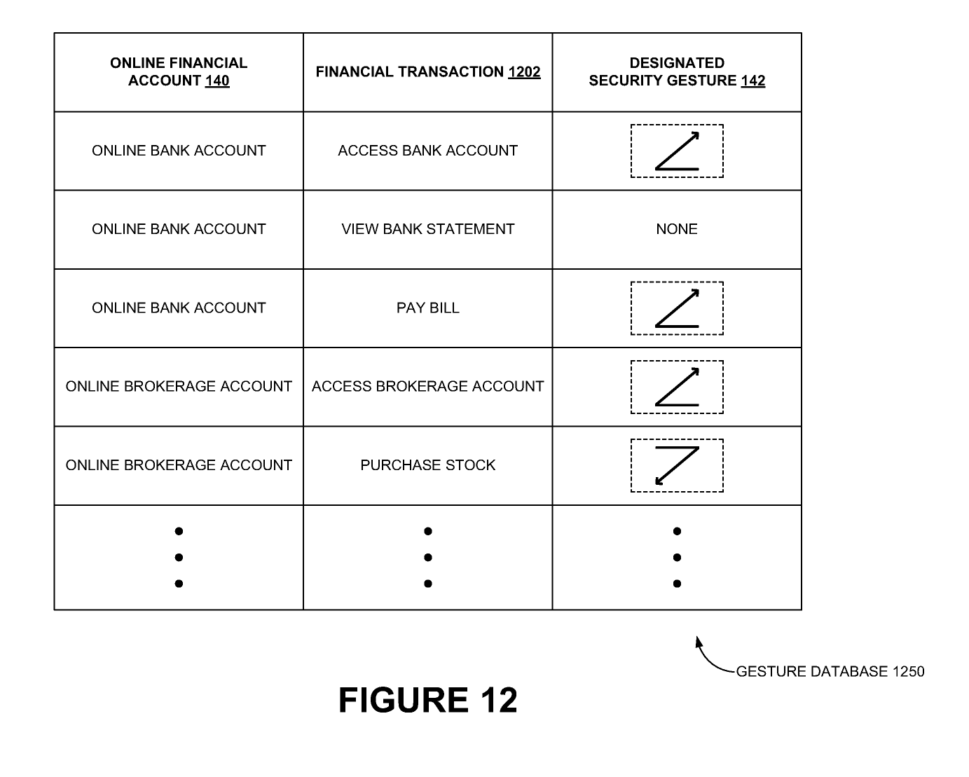

FIG. 12 is a database view of a designated security gesture associated with a financial transaction of an online financial account. In an illustrative example, the gesture database 1250 may comprise a column for the online financial account 140, the financial transaction 1202, and/or the designated security gesture 142. Examples of an online financial account 140 may be an online bank account or an online brokerage account. Examples of a financial transaction 1202 include access bank account, view bank statement, pay bill, access brokerage account, and purchase stock.

The designed security gesture 142 may be the required gesture to confirm the financial transaction 1202. To complete the financial transaction 1202 the applied gesture 108 may be required to match designed security gesture 142. In an example, to view the bank statement of an online bank account, a designated security gesture may not be required. The user 104 may be able to view the bank statement after completing the action to access the bank account without re-entering the designated security gesture 142. Accessing the bank account may require entering the designated security gesture 142.

In FIG. 12, to pay a bill through the online bank account, the designated security gesture 142 may need to be re-entered to increase the security of the financial transaction 1202. In the online brokerage account example, the designated security gesture 142 to access the brokerage account may be a different gesture than the designated security gesture 142 to purchase stock through the brokerage account. Using a different designated security gesture 142 may increase the security of the online financial account. The settings associated with the designated security gesture 142 and the financial transaction 1202 may be adjusted based on a preference of the user 104.

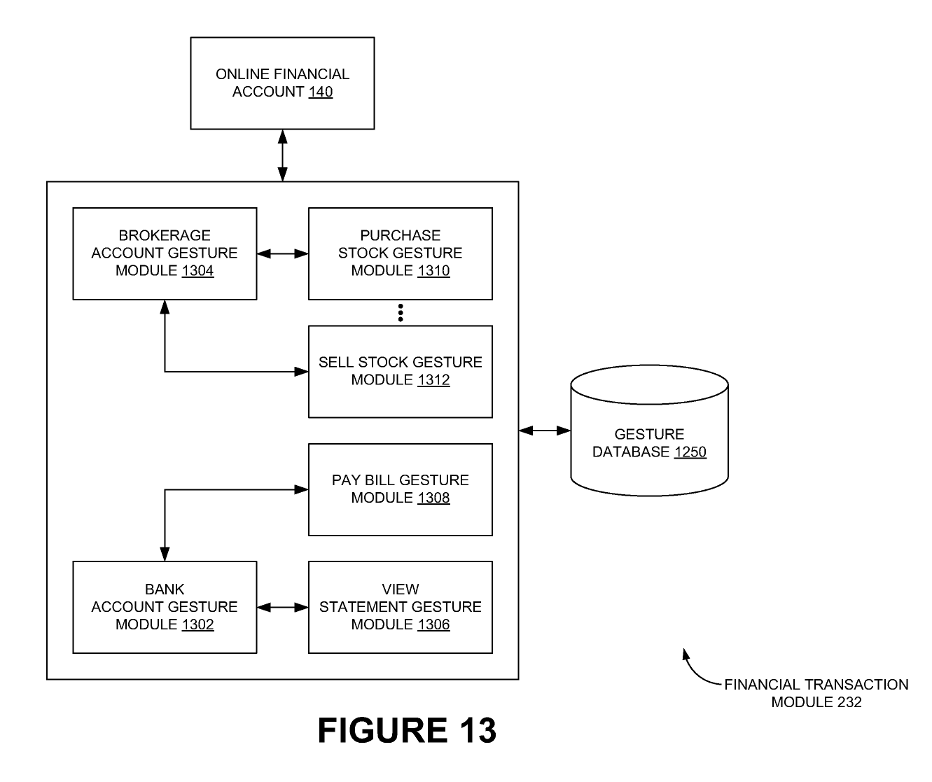

FIG. 13 is a block diagram illustrating the contents of a financial transaction module 232 and the processes within the financial transaction module 232, according to one embodiment. The financial transaction module 232 may comprise a bank account gesture module 1302, a brokerage account gesture module 1304, a view statement gesture module 1306, a pay bill gesture module 1308, a purchase stock gesture module 1310, and a sell stock gesture module 1312. The financial transaction module 232 may communicate with the gesture database 1250 and/or the online financial account 140.

The brokerage account gesture module 1304 may be linked to an online brokerage account such that the online brokerage account is accessible based on an applied gesture 108. The brokerage account gesture module 1304 may be linked to a purchase stock gesture module 1310 and/or sell stock gesture module 1312. For example, a request be a user 104 to purchase stock through an online brokerage account, may be processed through the purchase stock gesture module 1310 such that the applied gesture 108 may be verified against the designated security gesture 142 of the gesture database 1250.

The bank account gesture module 1302 may be linked to an online bank account such that the online bank account is accessible based on an applied gesture 108. The bank account gesture module 1302 may be linked to a pay bill gesture module 1308 and/or view statement gesture module 1306. For example, a request be a user 104 to pay a bill through an online bank account, may be processed through the pay bill gesture module 1308 such that the applied gesture 108 may be verified against the designated security gesture 142 of the gesture database 1250.

FIG. 14 is a system view illustrating a financial transaction involving stocks through an applied gesture on a mobile device, according to one embodiment. The user interface 138 of the mobile device 102 may comprise a stock transaction interface 1404. The stock transaction interface may comprise a stock chart 1402. The user 104 may be able to follow a particular publicly traded company through the stock chart 1402 and buy and/or sell shares through an applied gesture 108 on the gesture input area 1002 on the touchscreen 106 of the mobile device 102. The applied gesture 108 may be verified against the designated security gesture 142 of the gesture database 1250.

In an example situation incorporating the disclosure, a bank customer may want to access his online bank account through his mobile device. The bank customer may want to have a different security feature than a user identification and/or password to access his online bank account, because a user identification and/or password may be susceptible to phishing. The bank customer may be able to access his online bank account with an applied gesture on his mobile device. The bank customer may be able to use additional applied gestures to conduct banking transactions.

The modules of FIGS. 1-14 may be enabled using software and/or using transistors, logic gates, and electrical circuits (e.g., application specific integrated ASIC circuitry) such as a security circuit, a recognition circuit, a tactile pattern circuit, an association circuit, a store circuit, a transform circuit, an initial state circuit, an unlock circuit, a deny circuit, a determination circuit, a permit circuit, a user circuit, a region circuit, and other circuits.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
determining that an applied gesture on a touchscreen of a mobile device is associated with a user-defined gesture;
comparing the applied gesture above the touchscreen of the mobile device with a designated security gesture; and
permitting an access of an online financial account through the mobile device when the applied gesture above the touchscreen of the mobile device matches the designated security gesture.

2. The method of claim 1 further comprising authenticating the mobile device to access the online financial account such that a financial asset of the online financial account is controllable through the mobile device based on the designated security gesture.

3. The method of claim 2 further comprising restricting the access of the online financial account when the applied gesture above the touchscreen of the mobile device is different than the designated security gesture.

4. The method of claim 3 further comprising permitting a financial transaction when the applied gesture above the touchscreen of the mobile device matches the designated security gesture.

5. The method of claim 3 further comprising permitting a payment of a bill through the online financial account when the applied gesture above the touchscreen of the mobile device matches the designated security gesture, wherein the online financial account is an online bank account.

6. The method of claim 5 further comprising permitting a transfer of the financial asset of the online financial account when the applied gesture above the touchscreen of the mobile device matches the designated security gesture.

7. The method of claim 6 further comprising permitting a deposit of a bank cheque to the online financial account when the applied gesture above the touchscreen of the mobile device matches the designated security gesture.

8. The method of claim 7 further comprising permitting a review of an online statement of the online financial account when the applied gesture above the touchscreen of the mobile device matches the designated security gesture.

9. The method of claim 8 further comprising remotely enabling a user to define the user-defined gesture.

10. The method of claim 9 wherein the applied gesture and the user-defined gesture are dependent on a scale value and a position value within an input area of the mobile device.

11. The method of claim 9 wherein the applied gesture and the user-defined gesture are independent of a scale value and a position value within an input area of the mobile device.

12. The method of claim 9 wherein the designated security gesture is stored in a remote computer server.

13. The method of claim 3 further comprising confirming a financial transaction of the online financial account when the applied gesture above the touchscreen of the mobile device matches the designated security gesture, wherein the online financial account is an online brokerage account.

14. A method of a mobile device comprising:
processing an applied gesture on a touchscreen of a mobile device such that an online financial account is accessible through the mobile device based on the applied gesture;
determining that the applied gesture on a touchscreen of a mobile device is associated with a user-defined gesture;
comparing the applied gesture above the touchscreen of the mobile device with a designated security gesture; and
permitting an access of the online financial account through the mobile device when the applied gesture above the touchscreen of the mobile device matches the designated security gesture.

15. The method of claim 14 further comprising authenticating the mobile device to access the online financial account such that a financial asset of the online financial account is controllable through the mobile device based on the designated security gesture.

16. The method of claim 15 further comprising restricting the access of the online financial account when the applied gesture above the touchscreen of the mobile device is different than the designated security gesture.

17. The method of claim 16 further comprising permitting a payment of a bill through the online financial account when the applied gesture above the touchscreen of the mobile device matches the designated security gesture.

18. A method comprising:
determining that an applied gesture on a touch-receptive area of a mobile device is associated with a user-defined gesture;
comparing the applied gesture above the touch-receptive area of the mobile device with a designated security gesture; and
permitting an access of an online financial account through the mobile device when the applied gesture above the touch-receptive area of the mobile device matches the designated security gesture.

19. The method of claim 18 further comprising authenticating the mobile device to access the online financial account such that a financial asset of the online financial account is controllable through the mobile device based on the designated security gesture.

20. The method of claim 19 further comprising restricting the access of the online financial account when the applied gesture above the touch-receptive area of the mobile device is different than the designated security gesture.
